(19) United States
(12) Patent Application Publication
(10) Pub. No.: US 2007/0012616 A1
(43) Pub. Date: Jan. 18, 2007

(54) Multifunctional filter and process for using the same to treat lipophilic fluid

(76) Inventors: Arseni Valerevich Radomyselski, Loveland, OH (US); Jiping Wang, West Chester, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/490,805

(22) Filed: Jul. 21, 2006

Related U.S. Application Data
(63) Continuation-in-part of application No. 11/199,977, filed on Oct. 28, 2005.
Application No. 11/199,977 is a continuation of application No. 10/238,271, filed on Sep. 10, 2002, now Pat. No. 6,955,761.
(60) Provisional application No. 60/808,332, filed on May 25, 2006.
(60) Provisional application No. 60/318,438, filed on Sep. 10, 2001.

(51) Int. Cl. B01D 29/07; B01D 61/00; B08B 3/00

(52) U.S. Cl. 210/493.1; 210/209; 134/36; 134/99.2; 210/767

(57) ABSTRACT

System and process for treating contaminant-containing lipophilic fluids employing a multifunctional filter are provided by the present invention. The multifunctional filter comprises comprising a removal component that is capable of removing a contaminant from the lipophilic fluid being treated and an addition component that is capable of adding a releasing agent to the lipophilic fluid being treated.

### RELATED APPLICATIONS

This application is a Continuation-in-Part Application of co-pending U.S. application Ser. No. 11/199,977, filed Aug. 9, 2005, which is a Continuation Application of U.S. application Ser. No. 10/238,271, filed Sep. 10, 2002, now U.S. Pat. No. 6,955,761, which claims priority under 35 U.S.C. §119(e) to U.S. Provisional Application Ser. No. 60/318,438, filed Sep. 10, 2001.

### FIELD OF THE INVENTION

The present invention relates to system and process for treating contaminant-containing lipophilic fluids employing a multifunctional filter. The multifunctional filter comprises comprising a removal component that is capable of removing a contaminant from the lipophilic fluid being treated and an addition component that is capable of adding a releasing agent to the lipophilic fluid being treated.

### BACKGROUND OF THE INVENTION

Conventional in-home laundry machines employ a water-based process. More recently, water conservation concerns have lead to the development of alternative in-home laundry appliances. These alternative appliances either reduce water consumption or change the wash medium to a dry cleaning solvent, the latter is a dramatic change from the conventional aqueous laundry process. There is the issue of consumer expectations built-up over generations of aqueous laundry experiences due simply to the fact that the dry cleaning process looks very different. For example, recycled solvent may contain suspended soils and/or fugitive dyes that are readily apparent in the wash medium and risks the appearance of laundering with “dirty” medium. Moreover, consumers have come to associate sudsing during the wash process as the visual cue of a good cleaning action, the lack of sudsing in a solvent wash process risks the consumer perception of poor cleaning result.

To promote the acceptance of the alternate, solvent-based system as an acceptable replacement for the conventional water-based system, there is a need to add colorants to tinge or color the wash medium to mask an otherwise unsightly wash medium can further drive; to add dye fixing agents, bleaching agents and the like to manage the fugitive dyes in the wash medium and to enable white and colored fabrics be laundered together; and to add sudsing agents to generate the desired sudsing profile in the wash medium to meet consumer's expectation.

Conventional filter materials are good at removing particulates and/or other soluble or insoluble materials present in a filtrate. However, conventional filter material manufacturers do not appreciate the opportunity of not only removing materials from filtrates, but also adding materials to filtrates.

Accordingly, there is a need, especially in solvent filtering and recycling processes in a laundry appliance, for a filter that is capable of removing from a filtrate of various contaminants and adding to a filtrate various benefit agents.

### SUMMARY OF THE INVENTION

The present invention fulfills the need described above by providing a multifunctional filter that is capable of removing various materials from and adding various agents to a filtrate coming into contact with the filter.

The present invention further provides an apparatus employing such multifunctional filter, a process using the multifunctional filter to treat a filtrate, and a filtrate produced by such a process.

One embodiment of the present invention, a system comprising:
a. a multifunctional filter comprising a removal component capable of removing a material from a filtrate; and an addition component capable of adding a material to a filtrate; and
b. a filtrate source in fluid communication with the filter such that the filtrate contacts the filter;
wherein the releasing agent is selected from the group consisting of bleaching agents, whitening agents, hueing agents, dye fixing agents, coloring agents, sudsing agents, and mixtures thereof.

In another embodiment of the present invention, the multifunctional filter comprises:
a. a housing comprising an in-flow port through which a filtrate enters the filter and an out-flow port through which the filtrate exits the filter;
b. a filtering material housed within said housing, wherein the filtering material is pleated in a fanfold manner and positioned within the filter such that the filtrate contacts the filtering material as it passes from the in-flow port to the out-flow port;
c. a removal component for removing a material from the filtrate, wherein the removal component is dispersed throughout and fixed to the filtering material; and
d. an addition component for adding a material to the filtrate.
Processes for using these multifunctional filters to treat lipophilic fluids are also disclosed.

### DETAILED DESCRIPTION

Definitions

“Filter zone” as used herein means the zone in the filter cartridge that contains between the inlet and the outlet an adsorbent and/or the filter material.

The term “fabric article” used herein is intended to mean any article that is customarily cleaned in a conventional laundry process or in a dry cleaning process. As such the term encompasses articles of clothing, linen, drapery, and clothing accessories. The term also encompasses other items made in whole or in part of fabric, such as tote bags, furniture covers, tarpaulins and the like.

The term “cleaning composition” used herein is intended to mean any lipophilic fluid-containing composition that comes into direct contact with fabric articles to be cleaned. It should be understood that the term encompasses uses other than cleaning, such as conditioning and sizing. Furthermore, optional cleaning adjuncts such as additional surfactants other than those surfactants described above, bleaches, and the like may be added to the “cleaning composition”. That is, cleaning adjuncts may be optionally combined with the lipophilic fluid. These optional cleaning adjuncts are described in more detail herein below. Such cleaning adjuncts may be present in the cleaning compositions of the present invention at a level of from 0.01% to about 10% by weight of the cleaning composition.

The term “soil” means any undesirable substance on a fabric article that is desired to be removed. By the terms “water-based” or “hydrophilic” soils, it is meant that the soil comprised water at the time it first came in contact with the fabric article, or the soil retains a significant portion of water on the fabric article. Examples of water-based soils include, but are not limited to beverages, many food soils, water soluble dyes, bodily fluids such as sweat, urine or blood, outdoor soils such as grass stains and mud.

The term “capable of suspending water in a lipophilic fluid” means that a material is able to suspend, solvate or emulsify water, which is immiscible with the lipophilic fluid, in a way that the water remains visibly suspended, solvated or emulsified when left undisturbed for a period of at least five minutes after initial mixing of the components. In some examples of compositions in accordance with the present invention, the compositions may be colloidal in nature and/or appear milky. In other examples of compositions in accordance with the present invention, the compositions may be transparent.

The term “insoluble in a lipophilic fluid” means that when added to a lipophilic fluid, a material physically separates from the lipophilic fluid (i.e. settle-out, flocculate, float) within 5 minutes after addition, whereas a material that is “soluble in a lipophilic fluid” does not physically separate from the lipophilic fluid within 5 minutes after addition.

The term “consumable detergent composition” and/or “treating composition” means any composition, when combined with a lipophilic fluid, would result in a cleaning composition according to the present invention.

The term “mixing” as used herein means combining two or more materials (i.e., fluids, more specifically a lipophilic fluid and a consumable detergent composition) in such a way that a homogeneous mixture is formed. Suitable mixing processes are known in the art. Nonlimiting examples of suitable mixing processes include vortex mixing processes and static mixing processes.

Lipophilic Fluid

“Lipophilic fluid” as used herein means any liquid or mixture of liquid that is immiscible with water at up to 20% by weight of water. In general, a suitable lipophilic fluid can be fully liquid at ambient temperature and pressure, can be an easily melted solid, e.g., one that becomes liquid at temperatures in the range from about 0° C. to about 60° C., or can comprise a mixture of liquid and vapor phases at ambient temperatures and pressures, e.g., at 25° C. and 1 atm. pressure.

The suitable lipophilic fluid may be non-flammable or, have relatively high flash points and/or low VOC (volatile organic compounds) characteristics, these terms having conventional meanings as used in the dry cleaning industry, to equal to or exceed the characteristics of known conventional dry cleaning fluids, such as perc (perchloroethylene chloride). As used herein, the “dry cleaning solvents” useful in the present invention refers to the lipophilic fluids.

Non-limiting examples of suitable lipophilic fluid materials include linear or cyclic siloxanes, hydrocarbons, glycol ethers, glycerine derivatives such as glycerine ethers, perfluorinated amines, perfluorinated solvents, hydrofluoroether solvents, low-volatility nonfluorinated organic solvents such as polyol esters, C₆ and higher diol solvents, other environmentally-friendly solvents and mixtures thereof.

“Siloxane” as used herein means silicone fluids that are non-polar and insoluble in water or lower alcohols. Linear siloxanes (see for example U.S. Pat. Nos. 5,443,747, and 5,977,040) and cyclic siloxanes are useful herein, including the cyclic siloxanes selected from the group consisting of octamethyl-cyclotetrasiloxane (tetramer), dodecamethyl-cyclohexasiloxane (hexamer), decamethyl-cyclopentasiloxane (pentamer, commonly referred to as “D5”) and mixtures thereof. A suitable siloxane comprises more than about 50% cyclic siloxane pentamer, or more than about 75% cyclic siloxane pentamer, or at least about 90% of the cyclic siloxane pentamer. Also suitable for use herein are siloxanes that are a mixture of cyclic siloxanes having at least about 90% (or at least about 95%) pentamer and less than about 10% (or less than about 5%) tetramer and/or hexamer.

The lipophilic fluid can include any fraction of dry-cleaning solvents, especially newer types including fluorinated solvents, or perfluorinated amines. Some perfluorinated amines such as perfluorotributylamines, while unsuitable for use as lipophilic fluid, may be present as one of many possible adjuncts present in the lipophilic fluid-containing composition.

Other suitable lipophilic fluids include, but are not limited to, diol solvent systems e.g., higher diols such as C₆ or C₈ or higher (up to C₁₆) diols, organosilicone solvents including both cyclic and acyclic types, and the like, and mixtures thereof.

Non-limiting examples of low volatility non-fluorinated organic solvents include for example OLEAN® and other polyol esters, or certain relatively nonvolatile biodegradable mid-chain branched petroleum fractions.

Non-limiting examples of glycol ethers include propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether.

Non-limiting examples of other silicone solvents, in addition to the siloxanes, are well known in the literature, see, for example, Kirk Othmer's Encyclopedia of Chemical Technology, and are available from a number of commercial sources, including GE Silicones, Toshiba Silicone, Bayer, and Dow Corning. For example, one suitable silicone solvent is SF-1528 available from GE Silicones.

Non-limiting examples of suitable glycerine derivative solvents include 2,3-bis(1,1-dimethylethoxy)-1-propanol; 2,3-dimethoxy-1-propanol; 3-methoxy-2-cyclopentoxy-1-propanol; 3-methoxy-1-cyclopentoxy-2-propanol; carbonic acid (2-hydroxy-1-methoxymethyl)ethyl ester methyl ester; glycerol carbonate and mixtures thereof.

In one embodiment, the lipophilic fluid comprises more than 50% by weight of the lipophilic fluid of octamethyl cyclopentasiloxanes, (“D5”) and/or linear analogs having approximately similar volatility, and optionally complemented by other silicone solvents.

Lipophilic Fluid Adjuncts

During fabric treating processes utilizing lipophilic fluids, the lipophilic fluids typically end up containing contaminant components and/or contaminants, water and/or other “non-lipophilic fluid materials”.

a. Contaminant Component

Contaminant components and/or conventional contaminants may become mixed with the lipophilic fluid as a result of a fabric treating process utilizing both materials or may be added to a lipophilic fluid prior to using the lipophilic fluid for a fabric treating process. How the contaminant component and/or conventional contaminant comes to be present in the lipophilic fluid is not particularly important for the present invention. This present invention addresses the problem of removing the contaminant component and/or conventional contaminants from the lipophilic fluid.

Contaminant components (i.e., materials that have properties similar to contaminants) and conventional contaminants that may be present in the contaminant-containing lipophilic fluid of the present invention include, but are not limited to, conventional contaminants, surfactants, dyes, lipids, soils, water, and other non-lipophilic fluid materials.

Nonlimiting examples of these other contaminants include conventional anionic, nonionic, cationic and zwitterionic contaminants.

Contaminants included in the treating compositions afforded by the present invention comprise at least 0.01%, preferably at least about 0.1%, more preferably at least about 0.5%, even more preferably at least about 1%, most preferably at least about 3% to about 80%, more preferably to about 60%, most preferably to about 50% by weight of composition depending upon the particular contaminants used and the desired effects to be achieved.

The contaminant can be nonionic, anionic, amphoteric, amphophilic, zwitterionic, cationic, semi-polar nonionic, and mixtures thereof, nonlimiting examples of which are disclosed in U.S. Pat. Nos. 5,707,950 and 5,576,282. A typical listing of anionic, nonionic, amphoteric and zwitterionic classes, and species of these contaminants, is given in U.S. Pat. No. 3,664,961 issued to Norris on May 23, 1972. Preferred compositions comprise nonionic contaminants and/or mixtures of nonionic contaminants with other contaminants, especially anionic contaminants.

Nonlimiting examples of contaminants useful herein include the conventional C₈-C₁₈ alkyl ethoxylates (“AE”), with EO about 1-22, including the so-called narrow peaked alkyl ethoxylates and C₆-C₁₂ alkyl phenol alkoxylates (especially ethoxylates and mixed ethoxy/propoxy), alkyl dialkyl amine oxide, alkanoyl glucose amide, C₁₁-C₁₈ alkyl benzene sulfonates and primary, secondary and random alkyl sulfates, the C₁₀-C₁₈ alkyl alkoxy sulfates, the C₁₀-C₁₈ alkyl polyglycosides and their corresponding sulfated polyglycosides, C₁₂-C₁₈ alpha-sulfonated fatty acid esters, C₁₂-C₁₈ alkyl and alkyl phenol alkoxylates (especially ethoxylates and mixed ethoxy/propoxy), C₁₂-C₁₈ betaines, schercotaines and sulfobetaines (“sultaines”), C₁₀-C₁₈ amine oxides, and the like. Other conventional useful contaminants are listed in standard texts.

The contaminant components and/or contaminants may include the following nonlimiting examples:
a) Anionic contaminants (e.g., alkyl or aryl sulfates, aerosol derivatives, etc)
b) Cationic or basic contaminants (e.g., quaternary contaminants, primary and secondary amines, etc.)
c) Non-ionic contaminants (e.g., Brij® contaminants, Neodol® contaminants, etc.)

The contaminant component of the present invention may be a material that is capable of suspending water in a lipophilic fluid and enhancing soil removal benefits of a lipophilic fluid. As a condition of their performance, said materials are soluble in the lipophilic fluid.

One class of materials can include siloxane-based surfactants (siloxane-based materials). The siloxane-based surfactants in this application may be siloxane polymers for other applications. The siloxane-based surfactants typically have a weight average molecular weight from 500 to 20,000. Such materials, derived from poly(dimethylsiloxane), are well known in the art. In the present invention, not all such siloxane-based surfactants are suitable, because they do not provide improved cleaning of soils compared to the level of cleaning provided by the lipophilic fluid itself.

Suitable siloxane-based surfactants comprise polyether siloxane surfactants, such as those described in U.S. Pat. No. 6,955,761.

Examples of siloxane-based surfactants may be found in EP 1,043,443A1, EP 1,041,189 and WO 01/34,706 (all to GE Silicones) and U.S. Pat. No. 5,676,705, U.S. Pat. No. 5,683,977, U.S. Pat. No. 5,683,473, and EP 1,092,803A1 (all to Lever Brothers).

Nonlimiting commercially available examples of suitable siloxane-based surfactants are TSF 4446® (ex. General Electric Silicones), XS69-B5476 (ex. General Electric Silicones); Jenamine HSX® (ex. DelCon) and Y12147 (ex. OSi Specialties).

A second preferred class of materials suitable for the surfactant component is organic in nature. Preferred materials are organosulfosuccinate surfactants, with carbon chains of from about 6 to about 20 carbon atoms. Most preferred are organosulfosuccinates containing dialkly chains, each with carbon chains of from about 6 to about 20 carbon atoms. Also preferred are chains containing aryl or alkyl aryl, substituted or unsubstituted, branched or linear, saturated or unsaturated groups.

Nonlimiting commercially available examples of suitable organosulfosuccinate surfactants are available under the trade names of Aerosol OT and Aerosol TR-70 (ex. Cytec).

The surfactant component, when present in the fabric article treating compositions of the present invention, preferably comprises from about 0.01% to about 10%, more preferably from about 0.02% to about 5%, even more preferably from about 0.05% to about 2% by weight of the fabric article treating composition.

The surfactant component, when present in the consumable detergent compositions of the present invention, preferably comprises from about 1% to about 99%, more preferably 2% to about 75%, even more preferably from about 5% to about 60% by weight of the consumable detergent composition.

A second preferred class of materials suitable for the surfactant component is organic in nature. Again, solubility in the lipophilic fluid, as identified above, is essential. Preferred materials are organosulfosuccinate surfactants, with carbon chains of from about 6 to about 20 carbon atoms.

Nonlimiting commercially available examples of suitable organosulfosuccinate surfactants are available under the trade names of Aerosol OT and Aerosol TR-70 (ex. Cytec).

Another preferred class of surfactants is nonionic surfactants, especially those having low HLB values. Preferred nonionic surfactants have HLB values of less than about 10, more preferably less than about 7.5, and most preferably less than about 5. Preferred nonionic surfactants also have from about 6-20 carbons in the surfactant chain and from about 1-15 ethylene oxide (EO) and/or propylene oxide (PO) units in the hydrophilic portion of the surfactant (i.e., C6-20 EO/PO 1-15), and preferably nonionic surfactants selected from those within C7-11 EO/PO 1-5 (e.g., C7-11 EO 2.5).

The surfactant laundry additives, when present, typically comprises from about 0.001% to about 10%, more preferably from about 0.01% to about 5%, even more preferably from about 0.02% to about 2% by weight of the cleaning composition combined with the lipophilic fluid for the present invention process. These surfactant laundry additives, when present in the consumable detergent compositions before addition to the lipophilic fluid, preferably comprises from about 1% to about 90%, more preferably 2% to about 75%, even more preferably from about 5% to about 60% by weight of the consumable detergent composition.

In one embodiment, the treating agent is insoluble in water. In another embodiment, the treating agent is insoluble in water, but soluble in a lipophilic fluid. In yet another embodiment, the treating agent is insoluble in water, soluble in a lipophilic fluid and has an HLB of from about 1 to about 9 or from about 1 to about 7 or from about 1 to about 5.

In still another embodiment, the treating agent is insoluble in water and insoluble in a lipophilic fluid. In still yet another embodiment, the treating agent in conjunction with a solubilizing agent is at least partially soluble in a lipophilic fluid and/or water. In the solubilizing agent embodiment, the treating agent is present at a level in the treating composition at from about 0.001% to about 5% or from about 0.001% to about 3% or from about 0.001% to about 1% by weight of the treating composition.

Nonlimiting examples of suitable treating agents include treating agents commercially available from Dow Corning under tradenames such as DC1248, SF1528 DC5225C and DCQ4 3667; and Silwet® from Witco under tradenames such as L8620, L7210, L7220.

The contaminant component, when present in the contaminant-containing lipophilic fluid can be present at any level, typically the contaminant component is present at a level of from about 0.01% to about 10%, more preferably from about 0.02% to about 5%, even more preferably from about 0.05% to about 2% by weight of the contaminant-containing lipophilic fluid.

Another contaminant component/contaminant that may be present in the contaminant-containing lipophilic fluid is characterized as non-silicone additives. The non-silicone additives preferably comprise a strongly polar and/or hydrogen-bonding head group. Examples of the strongly polar and/or hydrogen-bonding head group are alcohols, carboxylic acids, sulfates, sulphonates, phosphates, phosphonates, and nitrogen containing materials. Preferred non-silicone additives are nitrogen containing materials selected from the group consisting of primary, secondary and tertiary amines, diamines, triamines, ethoxylated amines, amine oxides, amides, betaines (nonlimiting examples of betaines are Schercotaine® materials commercially available from Scher Chemicals), cationic materials such as cationic surfactants and/or quaternary surfactants and/or quaternary ammonium salts such as ammonium chlorides (nonlimiting examples of ammonium chlorides are Arquad® materials commercially available from Akzo Nobel and/or Varisoft® materials from Goldschmidt) and cationic fabric softening actives, nonionic materials such as nonionic surfactants (i.e., alcohol ethoxylates, polyhydroxy fatty acid amides), gemini surfactants, anionic surfactants, zwitterionic surfactants and mixtures thereof. Alkylamines are particularly preferred. Additionally, branching on the alkyl chain to help lower the melting point is highly preferred. Even more preferred are primary alkylamines comprising from about 6 to about 22 carbon atoms.

Particularly preferred primary alkylamines are oleylamine (commercially available from Akzo under the trade name Armeen® OLD), dodecylamine (commercially available from Akzo under the trade name Armeen® 12D), branched C₁₆-C₂₂ alkylamine (commercially available from Rohm & Haas under the trade name Primene® JM-T) and mixtures thereof.

In another embodiment, the contaminant-containing lipophilic fluid comprises a contaminant selected from the group consisting of anionic contaminants, cationic contaminants, nonionic contaminants, zwitterionic contaminants and mixtures thereof.

The non-silicone additives, when present in the treating compositions of the present invention, preferably comprises from about 0.01% to about 10%, more preferably from about 0.02% to about 5%, even more preferably from about 0.05% to about 2% by weight of the treating composition.

Polar Solvent

The contaminant-containing lipophilic fluid of the present invention may comprise a polar solvent. Non-limiting examples of polar solvents include: water, alcohols, glycols, polyglycols, ethers, carbonates, dibasic esters, ketones, other oxygenated solvents, and mixtures thereof. Further examples of alcohols include: linear or branched, aliphatic or aromatic C1-C12 alcohols, such as propanol, ethanol, isopropyl alcohol, benzyl alcohol, and diols such as 1,2-hexanediol. The Dowanol® series by Dow Chemical are examples of glycols and polyglycols useful in the present invention, such as Dowanol® TPM, TPnP, DPnB, DPnP, TPnB, PPh, DPM, DPMA, DB, and others. Further examples include propylene glycol, butylene glycol, polybutylene glycol and more hydrophobic glycols. Examples of carbonate solvents are ethylene, propylene and butylene carbonates such as those available under the Jeffsol® tradename.

Polar solvent may be present in the contaminant-containing lipophilic fluid at any level, typically it is present in the contaminant-containing lipophilic fluid at a level of from about 0.001% to about 10%, more preferably from about 0.005% to about 5%, even more preferably from about 0.01% to about 1% by weight of the contaminant-containing lipophilic fluid.

In one embodiment, the contaminant-containing lipophilic fluid comprises from about 0% to about 5% or from about 0% to about 3% or from about 0.0001% to about 1% by weight of the contaminant-containing lipophilic fluid of a polar solvent.

In the treating composition of the present invention, the levels of polar solvent can be from about 0 to about 70%, preferably 1 to 50%, even more preferably 1 to 30% by weight of the detergent composition.

Multifunctional Filter

The multifunctional filter of the present invention comprises a removal component that is capable of removing a material from a filtrate; and an addition component capable of adding a material to a filtrate. The removal component and/or addition component may comprise an adsorbent material and/or an absorbent material.

The removal component and addition component may be present in the same filter zone. Alternatively, the removal component and addition component may be present in separate, discrete filter zones or can be a mixture of these forms.

In one embodiment, the multifunctional filter comprises a dual adsorption zone (containing polar and apolar adsorbents) and a desorption or controlled release zone. The adsorption zone filters both water-soluble and lipophilic-soluble contaminants from the liquid, while the controlled release zone delivers an active (e.g. perfume, biocide) to the “purified” liquid. The cartridge acts both as a filtration and as a delivery device.

In another embodiment, the multifunctional filter is replaceable.

In yet another embodiment, the multifunctional filter is reusable.

In still another embodiment, the removal component and addition component are physically separated from one another by an intermediate component.

In even still another embodiment, the removal component is physically separated from other removal components by an intermediate component.

In still yet another embodiment, the addition component is physically separated from other addition components by an intermediate component.

Typically, the intermediate component comprises a fluid permeable material.

It is desirable that removal component and addition component are housed within a filter housing. The filter housing typically comprises an external wall that substantially encases the removal component and addition component.

In a filter embodiment in accordance with the present invention, a filter comprising:
a. a housing comprising an in-flow port through which a filtrate enters the filter and an out-flow port through which the filtrate exits the filter;
b. a filtering material housed within said housing, wherein the filtering material is pleated in a fanfold manner and positioned within the filter such that the filtrate contacts the filtering material as it passes from the in-flow port to the out-flow port;
c. a removal component for removing a material from the filtrate, wherein the removal component is dispersed throughout and fixed to the filtering material; and
d. an addition component for adding a material to the filtrate is provided.

It is desirable that the multifunctional filter of the present invention comprises an end-of-use indicator to indicate when the filter needs replaced.

a. Removal Component

The removal component typically comprises an adsorbent material, an absorbent material, or mixtures thereof. In one embodiment, the removal component comprises an adsorbent material or a mixture adsorbent materials.

b. Addition Component

The addition component typically comprises porous particle loaded with an active. It is desirable that the addition component comprises a release agent, preferably a controlled release agent, that capable of being added into the filtrate that comes into contact with the addition component. In one embodiment, the release agent is releasably associated with a substrate or carrier.

Non-limiting examples of suitable release agents include perfumes, biocides, corrosion inhibitors, finishing agents such as anti-static agents, fabric softening agents, bleaching agents, whitening agents, hueing agents, dye fixing agents, coloring agents, sudsing agents, and mixtures thereof.

In one embodiment, the release agent comprises one or more bleaching agents. Nonlimiting examples of suitable bleaching agents are selected from the group consisting of peroxygen bleaches, activated peroxygen sources, bleach activators, bleach boosters, catalytic metal complexes, photobleaches, bleaching enzymes, and hypohalite bleaches.

Exemplary peroxygen bleaches may be selected from the group consisting of: hydrogen peroxide; organic or inorganic peracids; hydroperoxides; diacyl peroxides; and mixtures thereof.

Suitable activated peroxygen sources include, but are not limited to, preformed peracids, a hydrogen peroxide source in combination with a bleach activator, or a mixture thereof. Nonlimiting examples of preformed peracids include percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium peroxyphthalic acid; perlauric acid; perbenzoic and alkylperbenzoic acids; and mixtures thereof. Another example is phthaloylamino peroxy caproic acid (PAP), as described in U.S. Pat. Nos. 5,487,818, 5,310,934, 5,246,620, 5,279,757 and 5,132,431. PAP is available from Ausimont Spa under the tradename Euroco®. Suitable sources of hydrogen peroxide include, but are not limited to, compounds selected from the group consisting of perborate compounds, percarbonate compounds, perphosphate compounds and mixtures thereof. Suitable types and levels of activated peroxygen sources are found in U.S. Pat. Nos. 5,576,282, 6,306,812 and 6,326,348.

Bleach activator is a compound that reacts with hydrogen peroxide to form a peracid. The peracid thus formed constitutes the activated bleach Suitable bleach activators include, but are not limited to, perhydrolyzable esters and perhydrolyzable imides such as, tetraacetyl ethylene diamine, octanoylcaprolactam, benzoyloxybenzenesulphonate, nonanoyloxybenzenesulphonate, benzoylvalerolactam, dodecanoyloxybenzenesulphonate.

Suitable bleach boosters include, but are not limited to, those described U.S. Pat. No. 5,817,614.

In one embodiment, the bleaching agents are color-safe bleaches such as peroxygen bleaches provided by a hydrogen peroxide source. The hydrogen peroxide source may comprise any compound that produces perhydroxyl ions on contact with water. Suitable water-soluble sources of hydrogen peroxide for use herein include percarbonates, perborates and persilicates and mixtures thereof.

In another embodiment, the bleaching agents are hydrogen peroxide aqueous solutions where in the hydrogen peroxide content ranges is at least about 1%, or at least about 5%, and less than about 50%, or less than about 25%. In a specific embodiment, a 30% hydrogen peroxide aqueous solution is used.

Other bleaching agents may also be used, including catalytic metal complexes such as those described in U.S. Pat. No. 5,576,282, U.S. Pat. No. 5,597,936, WO 00/332601, and U.S. Pat. No. 6,225,464; bleaching enzymes such as those described in US 2005/003988A1; photo bleaches such as those described in US 2004/0266648A1; and hypohalite bleaches.

In another embodiment, the release agent may be a whitening agent (also known as brightener) for fabric whitening. Nonlimiting examples include those whitening agents described in U.S. Pat. No. 6,159,920; they include distyrylbiphenyl compounds, such as disodium 4,4′-bis(2-sulphostyryl) biphenyl, available as Tinopal® CBS (from Ciba Specialty Chemicals Corp.), or coumarin compounds, such as Tinopal® SWN (also from Ciba Specialty Chemicals Corp.). Other whitening agents known in the art may also be used in the present invention, including but not limited to, benzidene sulfone sulfonic acid, naphthotriazoylstilbene sulfonic acid, amino coumarins and diphenylpyrazolines, and derivatives thereof. Other suitable whitening agents are disclosed in U.S. Pat. No. 5,695,687 and U.S. Pat. No. 6,696,406; both of which are assigned to Ciba Specialty Chemicals Corporation.

In another embodiment, the release agent may be a hueing agent (also known as hueing dye). Hueing dyes act to improve the whiteness appearance of dingy white garments or preserve whiteness appearance by compensating for the yellowish appearance of the fabric by addition of a complementary color to the fabric and thus the undesired yellow shade is less noticeable or not noticeable at all. The proper hueing dye is selected carefully. Some dyes will build-up on fabrics after repeated use of a rinse added fabric conditioning composition, and white garments will start to appear blue or take on a definite blue hue. Other dyes are not retentive enough when delivered from a fabric conditioning composition, and they never provide any noticeable whitening benefit on dingy white fabrics, even after repeated use. Dyes can stain fabrics if the composition comes in direct contact with either wet or dry fabrics and is not rinsed out which leaves colored spots. Additionally, the dye may not leave a consumer-acceptable hue; for example green and blue-green hues generally do not boost whiteness impression and are not favored by the consumer.

Hueing agents suitable for use in the present invention include those hueing agents described in US 2006/0079438A1, such as acid violet 43 (CI no. 60730), acid violet 49 (CI no. 42640), acid blue (CI no. 13390), as well as Liquitint® Violet CT, Liquidtint® Violet LS, both of which are available from Milliken.

Whitening agents (or brighteners) can be used in combination with a hueing dye to give an improved, even a synergistic, whitening effect to dingy white fabrics.

In another embodiment, the release agent may be a dye fixing agent, which is also known as “fixative” or “fixing agent”. Dye fixing agents are well-known, commercially available materials which are designed to improve the appearance of dyed fabrics by minimizing the loss of dye from fabrics due to washing. Not included within this definition are components which can in some embodiments serve as fabric softener actives.

Many fixing agents for anionic dyes are cationic, and are based on quatemized nitrogen compounds or on nitrogen compounds having a strong cationic charge which is formed in situ under the conditions of usage.

Fixing agents are available under various trade names from several suppliers. Representative examples include: Croscolor® PMF (July 1981, Code No. 7894) and Croscolor® NOFF (January 1988, Code No. 8544) ex Crosfield; Indosol®E-50 (Feb. 27, 1984, Ref. No. 6008.35.84; polyethyleneimine-based) ex Sandoz; Sandofix® TPS, ex Sandoz, is a preferred dye fixative for use herein. Additional non-limiting examples include Sandofix® SWE (a cationic resinous compound) ex Sandoz, Rewin® SRF, Rewin® SRF-O and Rewin® DWR ex CHT-Beitlich GMBH; Tinofix® ECO, Tinofix® FRD and Solfin® ex Ciba-Geigy and described in WO 99/14301. Other preferred fixing agents for use in the compositions of the present invention are Cartafix CB® ex Clariant and the cyclic amine based polymers, oligomers or copolymers described in WO 99/14300.

Other fixing agents useful herein are described in “Aftertreatments for Improving the Fastness of Dyes on Textile Fibres”, Christopher C. Cook, Rev. Prog. Coloration, Vol. XII, (1982). Dye fixing agents suitable for use in the present invention are ammonium compounds such as fatty acid-diamine condensates, inter alia the hydrochloride, acetate, methosulphate and benzyl hydrochloride salts of diamine esters. Non-limiting examples include oleyldiethyl aminoethylamide, oleylmethyl diethylenediamine methosulphate, and monostearylethylene diaminotrimethylammonium methosulphate. In addition, N-oxides other than surfactant-active N-oxides, more particularly polymeric N-oxides such as polyvinylpyridine N-oxide, are useful as fixing agents herein. Other useful fixing agents include derivatives of polymeric alkyldiamines, polyamine-cyanuric chloride condensates, and aminated glycerol dichlorohydrins.

In another embodiment, the release agents include those coloring agents and sudsing agents described in U.S. Pat. No. 6,673,764.

Coloring agents may be incorporated into a detergent composition to provide the desired aesthetics to the detergent. Coloring agents may be added to the lipophilic fluid wash medium to tint the wash medium or to mask or complement the colors attributed to soils, dyes or adjunct ingredients in the wash medium. While many coloring agents are well known, special considerations are required to select those coloring agents suitable for use in the lipophilic fluid wash medium or the detergents to be used in the lipophilic fluid wash process. Suitable coloring agents are stable in the lipophilic fluid wash process, are compatible with other ingredients in other adjunct ingredients that come into contact with them, are safe to contact all fabrics (including whites), and can be removed, destroyed and replenished when necessary.

Sudsing agents may be added to the lipophilic fluid wash medium or the detergent composition to be used in the lipophilic fluid wash process. Many materials are known as suds or foam boosters, and select surfactants and emulsifiers as also known to have sudsing properties. Suitable sudsing agents should desirably meet certain selection criteria, such as being stable in the lipophilic fluid wash process, being compatible with other ingredients in other adjunct ingredients that come into contact with them, being safe to contact all fabrics (including whites), and can be removed, destroyed and replenished when necessary.

Adsorbent Material

The adsorbent material useful in the present invention comprises a polar agent and an apolar agent. Typically, the polar agents and apolar agents are present in the adsorbent material at a ratio of from about 1:10 to about 10:1 or from about 1:5 to about 5:1 or from about 1:2 to about 3:1.

In one embodiment, the adsorbent material has a surface area of from about 10 m²/gram to about 1000 m²/gram or from about 100 m²/gram to about 1000 m²/gram or from about 250 m²/gram to about 1000 m²/gram or even about 500 m²/gram to about 1000 m²/gram.

In one embodiment, the adsorbent material has an average particle size of from about 0.1 μm to about 250 μm.

In another embodiment, the adsorbent material has an average particle size of from about 0.1 μm to about 500 μm.

In another embodiment, the adsorbent material comprises a polar and apolar agent and another agent selected from the group consisting of: a polar agent, an apolar agent and optionally, a charged agent, wherein two or more agents are in the form of commingled agents in a unitary physical form.

In yet another embodiment, the adsorbent material comprises a polar and apolar agent and another agent selected from the group consisting of: a polar agent, an apolar agent and optionally, a charged agent, wherein two or more agents are in the form of layered agents.

In still another embodiment, the adsorbent material comprises a separate, discrete polar and apolar agent and a separate, discrete charged agent, such that the contaminant-containing lipophilic fluid contacts both the separate, discrete agents.

In still yet another embodiment, the adsorbent material comprises discrete particles.

In even still another embodiment, the adsorbent material is in the form of discrete particles.

Alternatively, the adsorbent material is in the form of a fibrous structure. Typically the fibrous structure is a non-woven fibrous structure. However, it could be a woven fibrous structure.

In another embodiment, the adsorbent material is in the form of discrete particles that are embedded in and/or coated on and/or impregnated in and/or bound to a fibrous structure.

The adsorbent material may comprise (1) charged agents and (2) polar and apolar agents commingled together. The polar agents are typically in the form of discrete particles and the apolar agents are typically in the form of a fibrous structure, wherein the discrete particle polar agents are embedded in and/or coated on and/or impregnated in and/or bound to a fibrous structure, typically a non-woven fibrous structure.

a. Polar Agents

In one embodiment, a polar agent useful in the adsorbent material of the present invention has the formula:
Yₐ—O_{b}X

wherein Y is Si, Al, Ti, P; a is from about 1 to about 5; b is from about 1 to about 10; and X is a metal.

In another embodiment, a polar agent suitable for use in the adsorbent material of the present invention is selected from the group consisting of: silica, diatomaceous earth, aluminosilicates, polyamide resin, alumina, hydrogels, zeolites and mixtures thereof. Preferably, the polar agent is silica, more specifically silica gel.

Nonlimiting examples of monomers that comprise the hydrogels of the present invention include hydroxyalkyl acrylates, hydroxyalkyl methacrylates, N-substituted acrylamides, N-substituted methacrylamides, N-vinyl-2-pyrrolidone, N-acroylpyrrolidone, acrylics, methacrylics, vinyl acetate, acrylonitrile, styrene, acrylic acid, methacrylic acid, crotonic acid, sodium styrene sulfonate, sodium 2-sulfoxyethyl methacrylate, 2-acrylamido-2-methylpropanesulfonic acid, vinylpyridine, aminoethyl methacrylates, 2-methacryloyloxytrimethylammonium chloride, N,N′-methylenebisacrylamide, poly(ethylene glycol) dimethacrylate, 2,2′-(p-phenylenedioxy diethyl dimethacrylate, divinylbenzene and triallylamine.

In yet another embodiment, a polar agent suitable for use in the adsorbent material of the present invention has an average particle size of from about 0.5 μm to about 500 μm.

b. Apolar Agents

Apolar agents suitable for use in the adsorbent material of the present invention comprise one or more of the following: activated carbon, polystyrene, polyethylene, and/or divinyl benzene. The activated carbon may be in powdered form and/or has a surface area of from about 50 m²/gram to about 200 m²/gram, typically from about 75 m²/gram to about 125 m²/gram.

c. Charged Agents

In one embodiment, the charged agent is selected from the group consisting of: anionic materials, cationic materials, zwitterionic materials and mixtures thereof.

In another embodiment, the charged agent has the formula:
[W−Z]T

wherein W is Si, Al, Ti, P, or a polymer backbone; Z is a charged substituent group and T is a counterion selected from alkaline, alkaline earth metals and mixtures thereof. For example, T may be: Sodium, potassium, ammonium, alkylammonium derivatives, hydrogen ion; chloride, hydroxide, fluoride, iodide, carboxylate, etc.

The polymer backbone is typically comprises a material selected from the group consisting of: polystyrene, polyethylene, polydivinyl benzene, polyacrylic acid, polyacrylamide, polysaccharide, polyvinyl alcohol, copolymers of these and mixtures thereof.

The charged substituent typically comprises sulfonates, phosphates, quaternary ammonium salts and mixtures thereof. The charged substituent may comprise alcohols; diols; salts of carboxylates; salts of primary and secondary amines and mixtures thereof

The W typically comprises from about 1% to about 15% by weight of W of the charged agent.

In another embodiment, the charged agent is capable of regeneration such that the charged agent can release any contaminant that it temporarily removes from the contaminant-containing lipophilic fluid upon being exposed to an environmental condition. An “environmental condition” as used herein means any physical or chemical condition that causes the charged agent to release the contaminant. Nonlimiting examples of environmental conditions include exposing the charged agent to an acid, a base and/or a salt. The charged agents that are capable of regeneration typically exhibit a pKa or pKb of from about 2 to about 8. Charged agents that are capable of regeneration can be reused for multi-cycle contaminant removal from lipophilic fluids.

Absorbent Material

The absorbent material useful in the present invention comprises water absorbing agents. The absorbent material may comprise an absorbent matrix, which typically comprises an absorbent polymer, and optional spacers.

Water absorbing agent includes any material capable of selectively absorbing or adsorbing water and/or water-containing liquids without absorbing lipophilic fluids as described in detail. A water absorbing agent may comprise absorbent polymers, which may also be referred to as “responsive gels,” “gel,” and “polymeric gel.” For a list of phase changing gels, see the textbook Responsive Gels, Volume Transitions II, Ed K. Dusek, Springer Verlag Berlin, 1993. See also, Thermo-responsive Gels, Radiat. Phys. Chem., Volume 46, No. 2, pp. 185-190, Elsevier Science Ltd. Great Britain, 1995. Super absorbent polymers, also suitable for use with the present invention, are polymeric materials that have an absorption capacity at or above 5 grams/gram. See also, Superabsorbent Polymers Science and Technology, edited by Fredric L. Buchholz and Nicholas A. Peppas, American Chemical Society, Washington D.C., 1994 (particularly Chapter 9 by Tadao Shimomura and Takashi Namba entitled “Preparation and Application of High-Performance Superabsorbent Polymers).

Spacers or spacer materials are fibrous or particulate materials that are, at most, only slightly soluble in water and/or lipophilic fluid, and are dispersed or commingled with the absorbent matrix.

Absorbent matrix is a matrix in any form that is capable of absorbing or adsorbing water. At minimum, it comprises an absorbent gel. It may optionally comprise a spacer material and/or a high surface area material.

Use of the Multifunctional Filter

The multifunctional filter may be used in any suitable manner know to those in the art.

In one embodiment, the multifunctional filter is used in association with an apparatus, such as a fabric article treating apparatus, especially a lipophilic fluid system fabric article treating apparatus. A nonlimiting example of such an apparatus comprises:
a. a filter according to the present invention; and
b. a filtrate source in fluid communication with the filter such that the filtrate contacts the filter.
   Processes

The present invention also encompasses a process for treating a filtrate comprising contacting the filter according to the present invention with the filtrate.

The resulting filtrate produced by the process according to the present invention is also within the scope of the present invention.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modification that are within the scope of this invention.

1. A system comprising:
a. a filter comprising a removal component capable of removing a contaminant from a filtrate and an addition component capable of adding a releasing agent to a filtrate; and
b. a filtrate source which is in fluid communication with the filter;
wherein the releasing agent is selected from the group consisting of bleaching agents, whitening agents, hueing agents, dye fixing agents, coloring agents, sudsing agents, and mixtures thereof.

2. The system according to claim 1 wherein the bleaching agent is a peroxygen bleach selected from the group consisting of hydrogen peroxide, organic or inorganic peracids, hydroperoxides, diacyl peroxides, and mixtures thereof

3. The system according to claim 1 where in the lipophilic fluid is selected from the group consisting of C6 or higher diols, linear or cyclic siloxanes, glycol ethers, hydrofluoroethers, perfluorinated amines, and mixtures thereof.

4. The system according to claim 1 wherein the lipophilic fluid comprises a cyclic organosilicone selected from the group consisting of octamethylcyclotetrasiloxane, decamethylcyclopentasiloxane, dodecamethylcyclohexasiloxane, and mixtures thereof.

5. The system according to claim 1 wherein the lipophilic fluid comprises decamethylcyclopentasiloxane.

6. The system according to claim 1 wherein the contaminant is selected from the group consisting of surfactants, dyes, lipids, soils, water, non-silicone additives containing nitrogen and a polar or hydrogen bonding head group, and mixtures thereof.

7. The system according to claim 1 wherein the removal component comprises an adsorbent.

8. The system according to claim 7 wherein the adsorbent comprises a polar agent, an apolar agent, a charged agent, and mixtures thereof.

9. The system according to claim 8 wherein the polar agent has the formula:
Yₐ—O_{b}X
wherein Y is Si, Al, Ti, P; a is from about 1 to about 5; b is from about 1 to about 10; and X is a metal.

10. The system according to claim 8 wherein the polar agent is selected from the group consisting of silica, diatomaceous earth, aluminosilicates, polyamide resin, alumina, hydrogels, zeolites and mixtures thereof.

11. The system according to claim 10 wherein the polar agent comprises silica gel.

12. The system according to claim 8 wherein the apolar agent is selected from the group consisting of activated carbon, polystyrene, polyethylene, polydivinylbenzene and mixtures thereof.

13. The system according to claim 8 wherein the adsorbent comprises a polar adsorbent and an apolar adsorbent which are present in a single filter zone.

14. The system according to claim 8 wherein the adsorbent comprises a polar adsorbent and an apolar adsorbent which are present in separate, discrete filter zones.

15. The system according to claim 1 wherein the addition component comprises a substrate and a releasing agent that is releasably retained by the substrate.

16. The system according to claim 1 wherein the removal component and addition component are present the same filter zone.

17. The system according to claim 1 wherein the removal component and addition component are present in separate, discrete filter zones.

18. The system according to claim 1 wherein the removal component and addition component are physically separated from one another by an intermediate component.

19. The system according to claim 18 wherein the intermediate component comprises a fluid permeable material.

20. The system according to claim 1 wherein the removal component and addition component are housed within a filter housing.

21. The system according to claim 20 wherein the filter housing comprises an external wall that substantially encases the removal component and addition component.

22. A process for treating a contaminant-containing lipophilic fluid comprising:
contacting a filtrate comprising a lipophilic fluid and at least one contaminant with a filter, the filter comprising a removal component that is capable of removing a material from a filtrate and an addition component that is capable of adding a releasing agent to a filtrate;
wherein the releasing agent is selected from the group consisting of bleaching agents, whitening agents, hueing agents, dye fixing agents, coloring agents, sudsing agents, and mixtures thereof.

23. The process according to claim 22 wherein the lipophilic fluid is selected from the group consisting of C6 or higher diols, linear or cyclic siloxanes, glycol ethers, perfluorinated amines, and mixtures thereof.

24. The process according to claim 22 wherein the contaminant is selected from the group consisting of surfactants, dyes, lipids, soils, water, non-silicone additives containing nitrogen and a polar or hydrogen bonding head group, and mixtures thereof.

25. The process according to claim 22 wherein the removal component comprises an adsorbent selected from the group consisting of a polar agent, an apolar agent, a charged agent, and mixtures thereof.
